(19) United States
(12) Patent Application Publication
(10) Pub. No.: US 2010/0289710 A1
(43) Pub. Date: Nov. 18, 2010

(54) VEHICLE ANTENNA SYSTEM

(75) Inventor: Kazushige Ogino, Redwood (JP)

Correspondence Address: CHRISTIE, PARKER & HALE, LLP, PO BOX 7068, PASADENA, CA, 91109-7068, US

(73) Assignee: LG CHEM. LTD, SEOUL (KR)

(21) Appl. No.: 12/738,583

(22) PCT Filed: Nov. 11, 2008
(86) PCT No.: PCT/JP2008/070835

§ 371 Date: Apr. 16, 2010

(30) Foreign Application Priority Data
Oct. 18, 2007 (JP) 2007-271848
Aug. 5, 2008 (JP) 2008-201786

(51) Int. Cl. H01Q 1/32

(52) U.S. Cl. 343/713

(57) ABSTRACT

A system improving reception performance of a terrestrial digital broadcast loop antenna attached to the front windshield of a vehicle, provided with at least one loop antenna with directivity in a direction parallel to the vehicle length direction and at least two loop antennas with directivity in a direction away from a direction parallel to the vehicle length direction, wherein these loop antennas are all set near conductors that make up the vehicle. The loop antenna with directivity in a direction parallel to the length direction of the vehicle is, viewed from a vehicle interior, set near the top left-right vicinity of the front window, while the two loop antennas with directivity in a direction away from the direction parallel to the vehicle length direction are positioned adjacent to this loop antenna.

### TECHNICAL FIELD

The present invention relates to a vehicle antenna system. The present invention particularly relates to a vehicle antenna system comprising a plurality of loop antennas attached to parts around a front windshield of a vehicle.

### BACKGROUND ART

In the past, automobiles and other vehicles have been equipped with antennas enabling the reception of radio waves even during movement. The radio waves received by a vehicle for many years have principally been the medium waves (MW) for AM radio and the very high frequency (VHF) or ultrahigh frequency (UHF) waves for FM radio or television. However, in recent years, antennas for global positioning systems (GPS), antennas receiving digital terrestrial broadcasts, and other antennas receiving high frequency band radio waves have also been mounted in vehicles. Digital terrestrial TV hereon will be referred to as “DTV”.

When attaching these antennas on a moving body, that is, a vehicle, the locations where the antennas are set are generally the front windshield of the vehicle. When an antenna is attached to the front windshield, it is set at the top of the front windshield, so the antenna is formed on a transparent film sheet which is then attached to the front windshield by an adhesive (for example, see Japanese Patent Publication (A) No. 2006-270602). Such a film antenna is usually formed with a horizontally long loop antenna.

### DISCLOSURE OF THE INVENTION

However, a conventional loop antenna attached at the top of a front windshield to receive DTV broadcasts had directivity toward the vehicle front, so there was the problem that reception became difficult when the vehicle changed directions. To solve this problem, there is also an antenna diversity system in which a DTV antenna is also set on the rear windshield of the vehicle and the radio wave with the better reception sensitivity is selected and received. However, this antenna diversity system requires circuitry for switching antennas, circuitry for combining received radio waves, and other circuitry. Further, installation was difficult and the installation costs were high.

Therefore, the present invention has as its object to provide a cheap and easy-to-install vehicle antenna system providing on the front windshield of a vehicle exactly the minimum number of loop antennas changed in directivity so as to improve the reception directivity of DTV broadcasts and enable good reception of DTV broadcasts regardless of the orientation of the forward direction of the vehicle.

A vehicle antenna system according to the present invention for achieving this object is an antenna system mounted on a fixed window set on a vehicle which is provided with a loop antenna with directivity in a direction parallel to a vehicular length direction and with a loop antenna with directivity in a direction away from the direction parallel to the vehicle length direction, characterized in that the loop antenna with directivity in a direction parallel to the vehicle length direction has two feed terminals symmetrically positioned with respect to a center line which bisects the loop antenna left and right and in that the loop antenna with directivity in a direction away from the direction parallel to the vehicle length direction has two feed terminals positioned offset to either side of a center line which bisects the loop antenna left and right. The vehicle antenna system can take the following three aspects.

A first aspect is a vehicle antenna system wherein the loop antenna with directivity in a direction parallel to the vehicle length direction comprises, viewed from a vehicle interior, a first loop antenna set at a top left of the window and a second loop antenna set at a top right of the window, and the loop antenna with directivity in a direction away from the direction parallel to the vehicle length direction comprises, viewed from a vehicle interior, a third loop antenna set adjacent to the right side of the first loop antenna and a fourth loop antenna set adjacent to the left side of the second loop antenna.

The second aspect is a vehicle antenna system wherein the loop antenna with directivity in a direction parallel to the vehicle length direction comprises, viewed from a vehicle interior, a first loop antenna set at a top left of the window and a second loop antenna set at a top right of the window, the loop antenna with directivity in a direction away from the direction parallel to the vehicle length direction comprises, viewed from a vehicle interior, a third loop antenna set at a bottom left of the window and a fourth loop antenna set at a bottom right of the window, and the direction of offset for the two feed terminals provided by the third loop antenna is different than for that of the two feed terminals provided by the fourth loop antenna.

The third aspect is a vehicle antenna system wherein the loop antenna with directivity in a direction parallel to the vehicle length direction comprises, viewed from a vehicle interior, a first loop antenna set at a bottom left of the window and a second loop antenna set at a bottom right of the window, the loop antenna with directivity in a direction away from the direction parallel to the vehicle length direction comprises, viewed from a vehicle interior, a third loop antenna set at a top left of the window and a fourth loop antenna set at a top right of the window, and the direction of offset for the two feed terminals provided by the third loop antenna is different than for that of the two feed terminals provided by the fourth loop antenna.

Further, the fourth aspect is a vehicle antenna system wherein the loop antenna with directivity in a direction parallel to the vehicle length direction comprises, viewed from a vehicle interior, a first loop antenna set at either a top left or top right of the window, the loop antenna with directivity in a direction away from the direction parallel to the vehicle length direction comprises, viewed from a vehicle interior, a second loop antenna and third loop antenna set in a direction along the upper edge of the window and a fourth loop antenna set at either a bottom left or bottom right of the window, and the direction of offset for the two feed terminals provided by the second loop antenna is different than for that of the two terminals provided by the third loop antenna.

According to the vehicle antenna system of the present invention, the directivity of the plurality of loop antennas set on the front windshield of the vehicle is not limited to the vehicle length direction, but it is also in the width direction of the vehicle, so even if the forward direction of the vehicle changes, good reception of DTV radio waves is possible and therefore antenna reception performance is improved.

### BRIEF DESCRIPTION OF THE DRAWINGS

The above and other objects, features, advantages, and the like of the present invention are explained in detail using embodiments illustrated in the accompanying drawings.

FIG. 1A is a perspective view, seen from the vehicle interior, showing an automobile front windshield on which a vehicle antenna system of a first embodiment of the present invention is mounted and the surroundings of the same.

FIG. 1B is a plan view showing enlarged one of the loop antennas forming that the vehicle antenna shown in FIG. 1A.

FIG. 1C is a plan view showing enlarged the other of the loop antenna forming the vehicle antenna system shown in FIG. 1A.

FIG. 1D is a plan view showing enlarged another loop antenna forming the vehicle antenna system shown in FIG. 1A.

FIG. 1E is a plan view showing enlarged a modification of the loop antenna shown in FIG. 1C.

FIG. 2A is a perspective view showing the appearance of a connector and coaxial cable connected to a feed terminal of the loop antennas shown in FIG. 1A to FIG. 1E.

FIG. 2B is a disassembled perspective view showing the connector shown in FIG. 2A.

FIG. 3A is a view showing an example of a circuit board shown FIG. 2B as seen from the bottom surface side.

FIG. 3B is a block circuit diagram showing the internal structure of an amplifier mounted on the circuit board shown in FIG. 3A.

FIG. 3C is a view of another example of a circuit board shown in FIG. 2B as seen from the bottom surface side.

FIG. 4A is a plan view showing the structure of a double loop antenna that can be used in place of the loop antenna shown in FIG. 2B.

FIG. 4B is a perspective view showing the structure of a connector connected to a feed terminal of the loop antenna shown in FIG. 4A.

FIG. 5 is a circuit diagram showing the connection of a vehicle antenna system of a first embodiment of the present invention to a navigation system mounted in a vehicle.

FIG. 6A is an explanatory view showing directivity when the film antenna shown in FIG. 1D is set near a dielectric body.

FIG. 6B is an explanatory view showing directivity when the film antenna shown in FIG. 1B is set near a dielectric body.

FIG. 6C is an explanatory view showing directivity when the film antenna shown in FIG. 1C is set near a dielectric body.

FIG. 6D is an explanatory view showing vertical directivity when the film antenna shown from FIG. 6A to FIG. 6C is set at the top of the front windshield of an automobile.

FIG. 7A is a perspective view, seen from the vehicle interior, showing an automobile front windshield on which a vehicle antenna system of a second embodiment of the present invention is mounted and the surroundings of the same.

FIG. 7B is a perspective view, seen from the vehicle interior, of only the front windshield of the automobile showing the structure of a modification of the vehicle antenna system shown in FIG. 7A.

FIG. 7C is a plan view showing enlarged one of the loop antennas forming the vehicle antenna system shown in FIG. 7B.

FIG. 7D is a plan view showing enlarged the other of the loop antennas forming the vehicle antenna system shown in FIG. 7A.

FIG. 8 is an explanatory view showing the vertical directivity of a film antenna set at the bottom of the front windshield of the automobile in a vehicle antenna system of a second embodiment of the present invention.

FIG. 9A is a perspective view, seen from the vehicle interior, of only the front windshield of the automobile on which a vehicle antenna system of a third embodiment of the present invention is mounted.

FIG. 9B is a perspective view, seen from the vehicle interior, of only the front windshield of the automobile showing the structure of a modification of the vehicle antenna system shown in FIG. 9A.

FIG. 9C is a perspective view, seen from the vehicle interior, of only the front windshield of the automobile on which a vehicle antenna system of a fourth embodiment of the present invention is mounted.

FIG. 9D is a perspective view, seen from the vehicle interior, of only the front windshield of the automobile on which a vehicle antenna system of a fifth embodiment of the present invention is mounted.

FIG. 10A is a plan view of an automobile showing the directivity of four antennas on the front windshield of an automobile mounted with the vehicle antenna system of the first embodiment of the present invention shown in FIG. 1A.

FIG. 10B is a plan view of an automobile showing the directivity of four antennas on the front windshield of an automobile mounted with the vehicle antenna system of the second embodiment of the present invention shown in FIG. 6A.

FIG. 10C is a plan view of an automobile showing the directivity of four antennas on the front windshield of an automobile mounted with the vehicle antenna system of the third embodiment of the present invention shown in FIG. 7A.

FIG. 10D is a plan view of an automobile showing the directivity of four antennas on the front windshield of an automobile mounted with the vehicle antenna system of the fourth embodiment of the present invention shown in FIG. 7C.

FIG. 10E is a plan view of an automobile showing the directivity of four antennas on the front windshield of an automobile mounted with the vehicle antenna system of the fifth embodiment of the present invention shown in FIG. 7D.

### BEST MODE FOR CARRYING OUT THE INVENTION

Below, the attached drawings will be used to explain in detail the modes of carrying out the vehicle antenna system of the present invention based on specific embodiments where the system is set on the front windshield of an automobile.

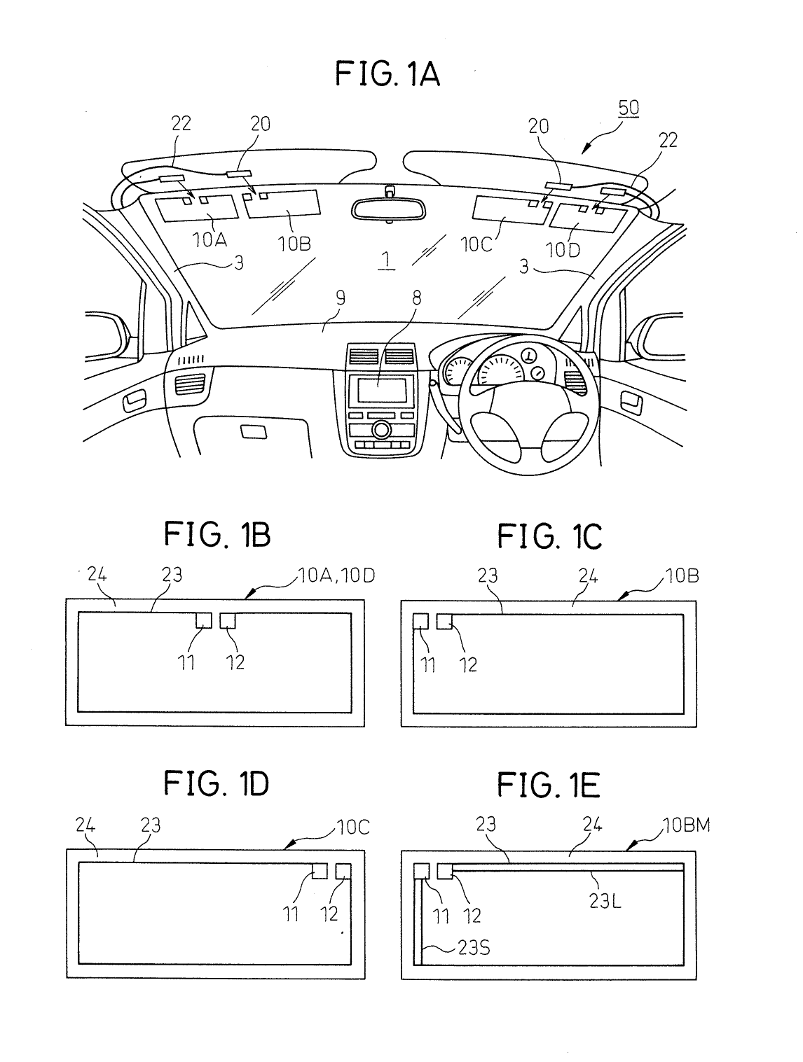

FIG. 1A shows the structure of a vehicle antenna system 50 according to a first embodiment of the present invention attached to the top of the left and right of a front windshield 1 of an automobile. It shows the front windshield 1 of the automobile and the surroundings of the same from the vehicle interior. The antenna system 50 of this embodiment is for receiving a DTV broadcast and comprises four film antennas 10A, 10B, 10C, and 10D. The four film antennas 10A, 10B, 10C, and 10D are each connected to a feed circuit comprised of a connector 20 and coaxial cable 22.

The signals that are received by the film antennas 10A, 10B, 10C, and 10D are input into the feed circuits provided with the coaxial cables 22 through the connectors 20. The coaxial cables 22 are situated along the A pillars 3 of the automobile and connected to a digital TV tuner not shown in the drawing. Reference notation 8 is a car navigation system set in the instrument panel 9 of the automobile. This receives image signals from the tuner as input.

FIG. 1B shows enlarged the film antenna 10A mounted at the top of the left side of the front windshield 1 of the automobile shown in FIG. 1A or the film antenna 10D mounted at the top of the right side of the same. The film antenna 10A (10D) uses a loop antenna having a rectangular-shaped antenna conductor 23. The loop antenna is provided with a rectangular antenna conductor 23 formed on a sheet-like transparent film 24 by conductive ink or copper foil or another conductor and feed terminals 11, 12 feeding power to the antenna conductor 23. In the film antenna 10A (10D), the feed terminals 11, 12 are arranged at symmetric positions about a center line which bisects the film antenna 10A (10D) left and right.

FIG. 1C shows enlarged the film antenna 10B set adjacent to the right side of the film antenna 10A mounted at the top of the left side of the front windshield 1 of the automobile shown in FIG. 1A. The film antenna 10B uses a loop antenna having a rectangular-shaped antenna conductor 23. The loop antenna is provided with a rectangular antenna conductor 23 formed on a sheet-like transparent film 24 and feed terminals 11, 12 feeding power to the antenna conductor 23. In the film antenna 10B, the feed terminals 11, 12 are offset to the left side of a center line which bisects the film antenna 10B left and right and are arranged near the left side end.

FIG. 1D shows enlarged the film antenna 10C set adjacent to the left side of the film antenna 10D mounted at the top of the right side of the front windshield 1 of the automobile shown in FIG. 1A. The film antenna 10C uses a loop antenna having a rectangular-shaped antenna conductor 23. The loop antenna is provided with a rectangular antenna conductor 23 formed on a sheet-like transparent film 24 and feed terminals 11, 12 feeding power to the antenna conductor 23. In the film antenna 10C, the feed terminals 11, 12 are offset to the right side of a center line which bisects the film antenna 10B left and right and are arranged near the right side end.

FIG. 1E shows the structure of a film antenna 10BM showing a modification of the film antenna 10B in FIG. 1C. In the film antenna 10BM, an antenna conductor 23S in the lateral direction adjacent to the feed terminal 11 of the film antenna 10B and an antenna conductor 23L in the longitudinal direction adjacent to the feed terminal 12 are each comprised of two conductor lines. This is to match the impedance.

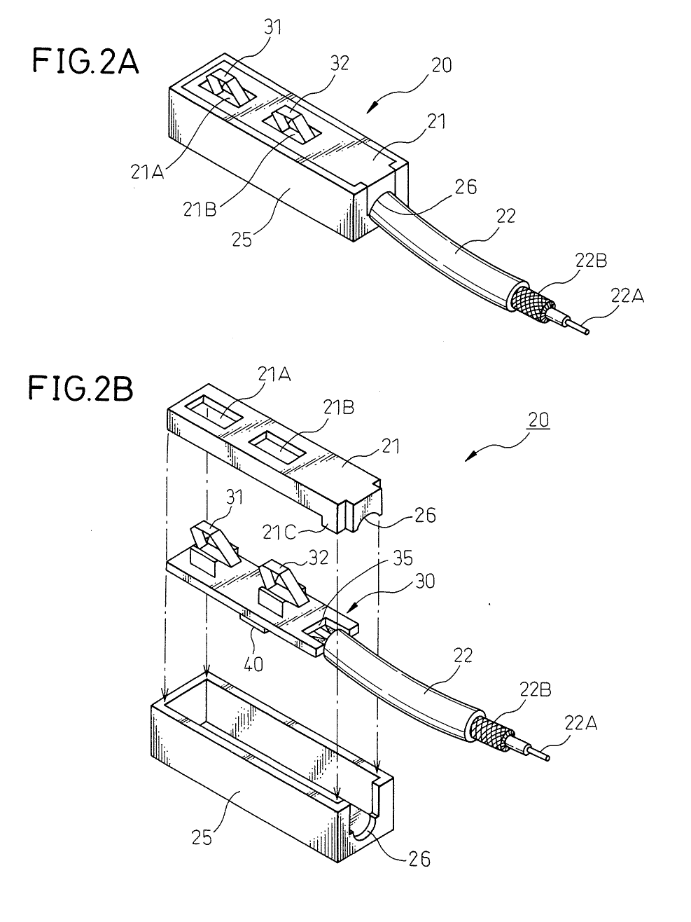

FIGS. 2A and 2B show the appearance of the connector 20 shown in FIG. 1A and the connector 20 in a disassembled state. As shown in FIG. 2A, the connector 20 comprises a combination of an inner case 21 and outer case 25. The surface of the inner case 21 of the connector 20 (the surface the antenna 10 is mounted to) has two openings 21A, 21B. Connection terminals 31, 32 having springiness protrude from these openings 21A, 21B. The connector 20 is fixed on top of each of the feed terminals 11, 12 of the antennas 10A, 10B, 10C, and 10D with two-sided adhesive tape or other adhesive stuck on the surface of the inner case 21.

The connection terminals 31, 32, as shown in FIG. 2B, are mounted on one surface of the circuit board (dielectric board) 30 built in the inner case 21 and outer case 25. The circuit board 30 is connected to a coaxial cable 22. The other surface of the circuit board 30 is equipped with an integrated circuit 40 to be mentioned later. Generally, the connection terminal 31 is the hot side (signal transmission side) terminal, and the connection terminal 32 is the ground side terminal.

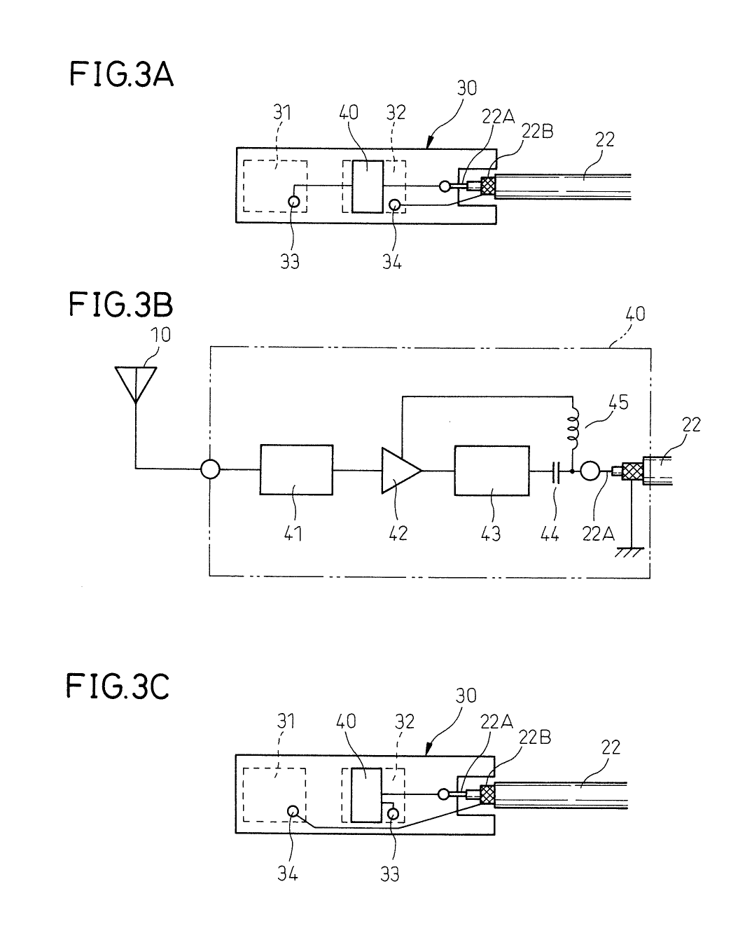

FIG. 3A shows the general structure of the circuit board 30 inside the connector 20 shown in FIG. 2B excluding the inner case 21 and outer case 25. Connection terminals 31, 32 are mounted on the bottom surface side of the circuit board 30 and are led to the top surface side of the circuit board 30 by the through holes 33, 34. In this example, the through hole 33 is connected to the input terminal of the integrated circuit 40 mounted on the top surface of the circuit board 30, and the through hole 34 is connected to the ground line (outside conductor) 22B of the coaxial cable 22. The integrated circuit 40 amplifies and otherwise processes the signals received by the antennas and outputs the processed signals to a center conductor (inner side conductor) 22A of the coaxial cable 22.

FIG. 3B shows the internal structure of the integrated circuit 40 shown in FIG. 3A. The integrated circuit 40 has inside it a filter 41 connected to the antenna 10, an amplifier 42 amplifying a signal output from the filter 41, and a filter 43 determining the signal band output from the amplifier 42. This filter 43 is connected to the center conductor 22A of the coaxial cable 22 through a capacitor 44 which blocks direct current. This coaxial cable 22 is a cable also supplying power. The power voltage (direct current) is supplied to the amplifier 42 through the coil 45 blocking the alternate current component.

FIG. 3C shows the structure of a circuit board 30 different from the connector 20 shown in FIG. 3A excluding the inner case 21 and outer case 25. In the circuit board 30 of the connector 20 shown in FIG. 3A, the connection terminal 31 is the hot side (signal transmission side) terminal which is connected to the input terminal of the integrated circuit 40 through the through hole 33, and the connection terminal 32 is the ground side terminal which is connected to the ground line 22B of the coaxial cable 22 through the through hole 34. On the other hand, in the circuit board 30 of the connector 20 shown in FIG. 3C, the connection terminal 31 is the ground side terminal, and the connection terminal 32 is the hot side (signal transmission side) terminal. The connection terminal 31 is connected to the ground line 22B of the coaxial cable 22 through the through hole 34, and the connection terminal 32 is connected to the input terminal of the integrated circuit 40 through the through hole 33. In this way, the connection terminal 31 may also be made the ground side terminal and the connection terminal 32 the hot side terminal.

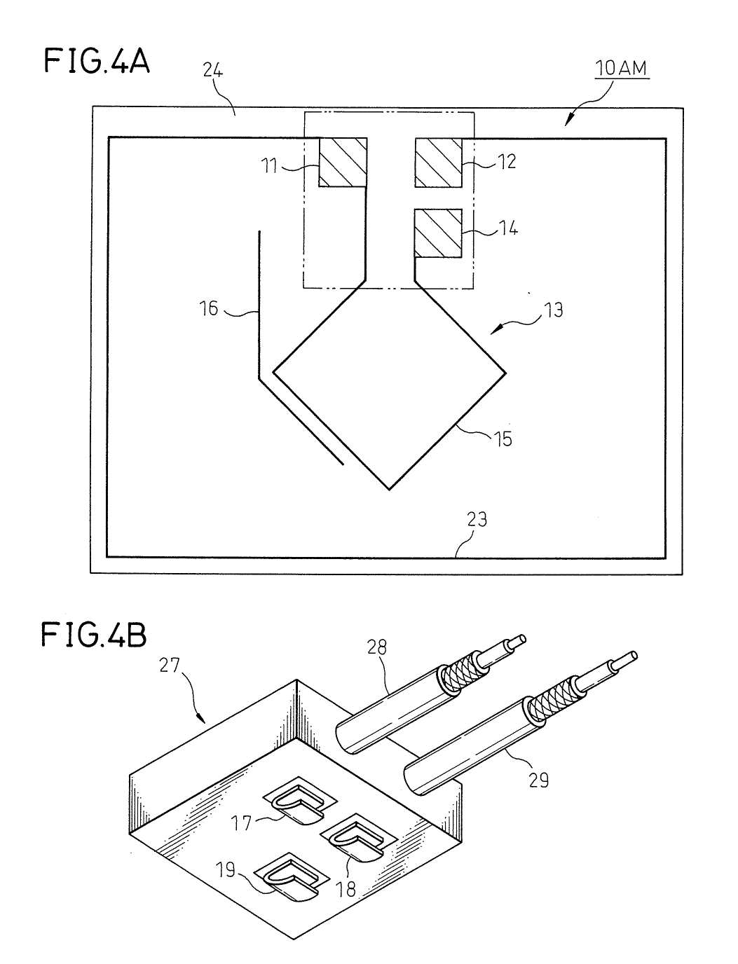

FIG. 4A is a plan view showing the structure of the film antenna 10AM provided with a doubled loop antenna that can be used in place of the film antenna 10A shown in FIG. 1B. The film antenna 10AM is an integrated antenna and comprises a GPS antenna 13 provided inside an antenna conductor 23 of a DTV loop antenna. This is because the GPS antenna 13 has a reception frequency that is higher than the frequency of a DTV broadcast, so the size of the antenna conductor 15 of the loop antenna can be made smaller than the size of the antenna conductor 23 of the film antenna 10AM. The GPS antenna 13 comprises a rectangular antenna conductor 15 and a parasitic element 16 positioned adjacent to this antenna conductor 15. The antenna conductor 15 and the parasitic element 16 are also formed on top of a sheet-like transparent film 24 by a conductive ink or copper foil or other conductor.

The two feed terminals of the GPS antenna 13 of this embodiment are situated near the two feed terminals 11, 12 of the DTV film antenna 10AM, so while a hot side feed terminal 14 is arranged separate from the feed terminal 12 of the hot side and the feed terminal 11 of the ground side of the film antenna 10AM, its ground side feed terminal is shared with the ground side feed terminal 11 of the film antenna 10AM.

Therefore, the feed terminals 11, 14 of the GPS film antenna 13 and the feed terminals 11, 12 of the DTV film antenna 10AM can be connected to one connector 27 provided with the three connection terminals 17, 18, and 19 shown in FIG. 4B. The connection terminals 17, 18, and 19 of the connector 27 are connected to the feed terminals 14, 12, and 11 respectively. This connector 27 is connected to a coaxial cable 28 extracting received signals of radio waves emitted from the GPS and a coaxial cable 29 extracting received signals of DTV broadcast. The connection terminals 17, 18, and 19 are provided with springiness. Two-sided adhesive tape is attached to the area around the connection terminals 17, 18, and 19 of the connector 27. Therefore, when connecting the connector 27 to the feed terminals 14, 12, and 11, it is sufficient to peel off the release paper of the two-sided adhesive tape, then attach the connection terminals 17, 18, and 19 to the position marked by the chain line shown in FIG. 4A so that they are over the feed terminals 14, 12, and 11. The attachment position of the connector 27 on the transparent film 24 is actually marked etc.

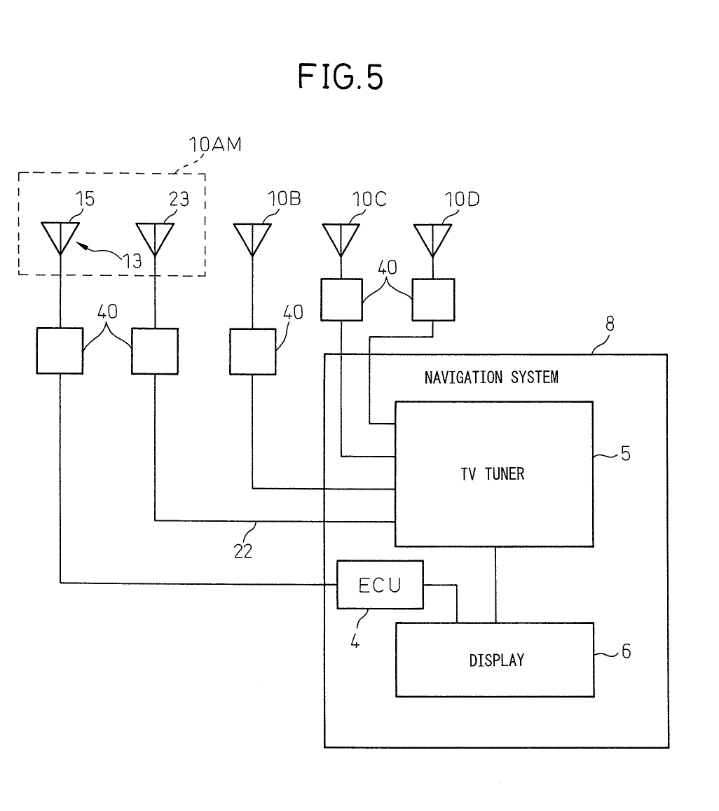

FIG. 5 is a circuit diagram showing the connection of the vehicle antenna system 50 of the first embodiment to a navigation system 8 mounted in the vehicle. The antenna system 50 of this embodiment uses the film antenna 10AM shown in FIG. 4A and the film antennas 10D, 10B, and 10C shown in FIGS. 1B, 1C, and 1D. Further, in this embodiment, there is a built-in TV tuner 5 in the navigation system 8, however, the TV tuner 5 may also be separate from the navigation system 8.

In this embodiment, the antenna conductor 23 in the film antenna 10AM and the film antennas 10B, 10C, and 10D are antennas receiving terrestrial digital TV radio waves, while the antenna conductor 15 in the film antenna 10AM is a GPS antenna. The DTV signals received by these film antennas 10AM, 10B, 10C, and 10D are guided to the TV tuner 5 with cables 22 through integrated circuits 40 built inside the connectors and performing amplification and the like. A demodulated image is displayed in the display 6 when the navigation system 8 is in the TV mode. Further, the GPS signals received by the GPS antenna 13 (antenna conductor 15) mounted in the film antenna 10AM are guided through an integrated circuit 40 and cable 22 to an ECU 4 of the navigation system 8. The current location of the automobile is detected and displayed on the display 6 of the navigation system 8 together with map information.

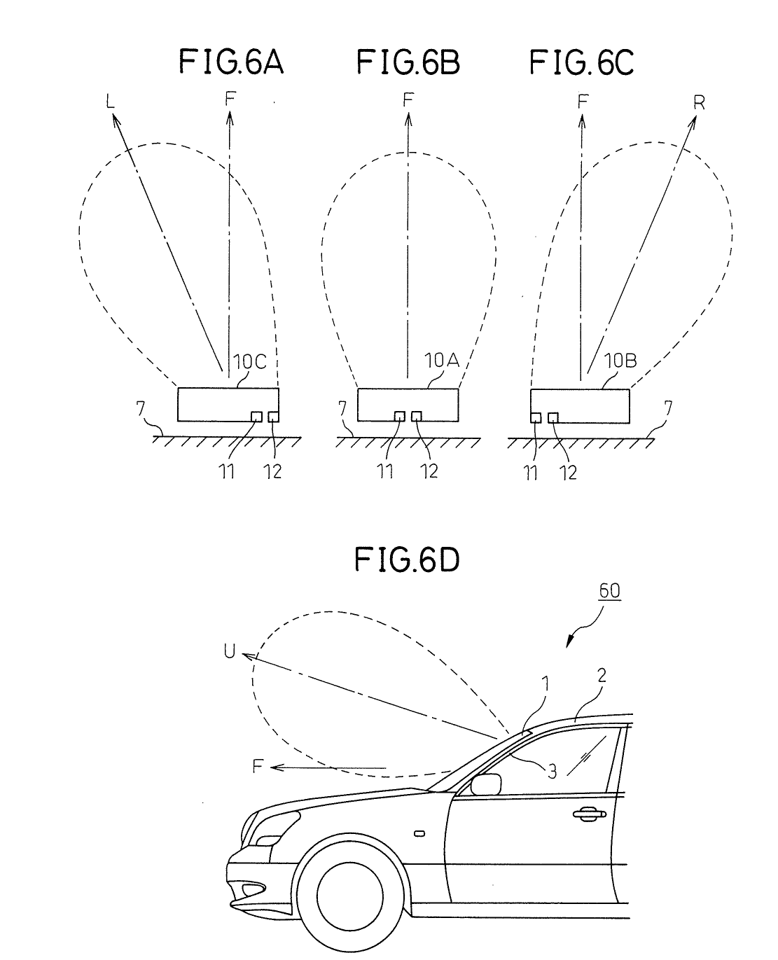

Here, the antenna directivity when receiving DTV broadcasts will be explained for the vehicle system 50 with the film antennas 10A, 10B, 10C, and 10D arranged as in FIG. 1A. FIG. 6A shows the directivity when the film antenna 10C shown in FIG. 1D is set near a dielectric body 7. This figure is a view of the film antenna 10C seen from the top of the automobile when it is set at the top part of the front windshield of the automobile. The dielectric body 7 in this case is the roof 2 of the automobile. The feed terminals 11, 12 are offset to the right of the center line bisecting the film antenna 10C left and right. Since the feed terminals 11, 12 are provided on the right side of the film antenna 10C, the directivity is toward the left side L of the forward direction F of the vehicle. Note that, the directivity shown by the broken line in FIG. 6A shows that the approximate direction of the directivity and is not an accurate depiction of the directivity.

FIG. 6B shows the directivity when the film antenna 10A shown in FIG. 1A is set near the dielectric body. Here too, the film antenna 10A is deemed to be set at the top part of the front windshield of the automobile. The figure is a view when viewing the automobile from above. The dielectric body 7 is the roof 2 of the automobile. Feed terminals 11, 12 are provided at symmetric positions with respect to a center line bisecting the film antenna 10A left and right. The directivity is toward the forward direction F of the vehicle. Note that, the directivity shown by the broken line shows the approximate direction of the directivity and is not an accurate depiction of the directivity.

FIG. 6C shows the directivity when the film antenna 10B shown in FIG. 1A is set near the dielectric body. Here too, the film antenna 10B is deemed to be set at the top part of the front windshield of the automobile. The figure is a view when viewing the automobile from above. The dielectric body 7 is the roof 2 of the automobile. Feed terminals 11, 12 are offset to the left of a center line bisecting the film antenna 10B left and right. Since the feed terminals 11, 12 are provided at the left side of the film antenna 10B, the directivity is toward the right side R of the forward direction F of the vehicle.

FIG. 6D shows the vertical directivity when the film antennas 10C, 10A, and 10B shown from FIG. 6A to FIG. 6C are set near the roof 2 on the top part of the front windshield 1 of the automobile 60. Here as well, the directivity shown by the broken line shows the approximate direction of the directivity and is not an accurate depiction of the directivity. The film antennas 10C, 10A, and 10B are for DTV, so the vertical directivity of these antennas is slanted upward with respect to the forward direction F of the vehicle.

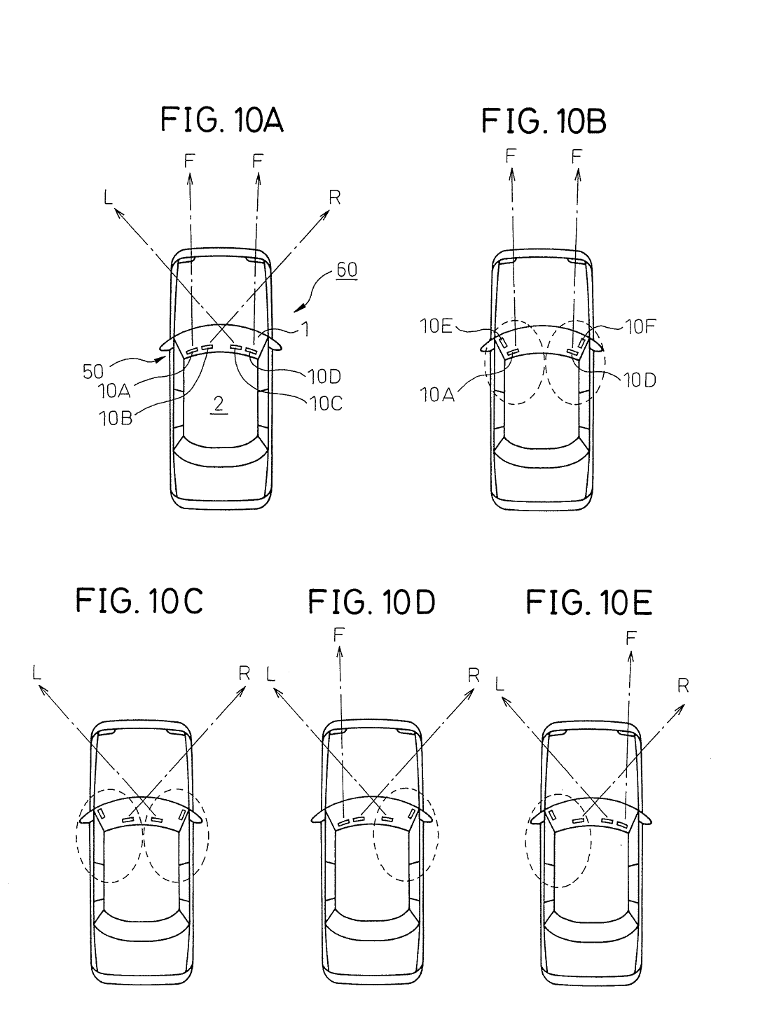

Therefore, the directivity of the antenna system 50 when the film antenna 10A, 10B, 10C, and 10D are arranged on the front windshield 1 of the automobile 60 as shown in FIG. 1A is as shown in FIG. 10A when the automobile 60 is seen from above. The range over which DTV broadcasts can be received expands out to a left direction L and right direction R with respect to the forward direction F of the vehicle. As a result, even if the vehicle changes its forward direction, it is able to receive radio waves of DTV broadcasts well, so the reception performance of the antenna system 50 is improved.

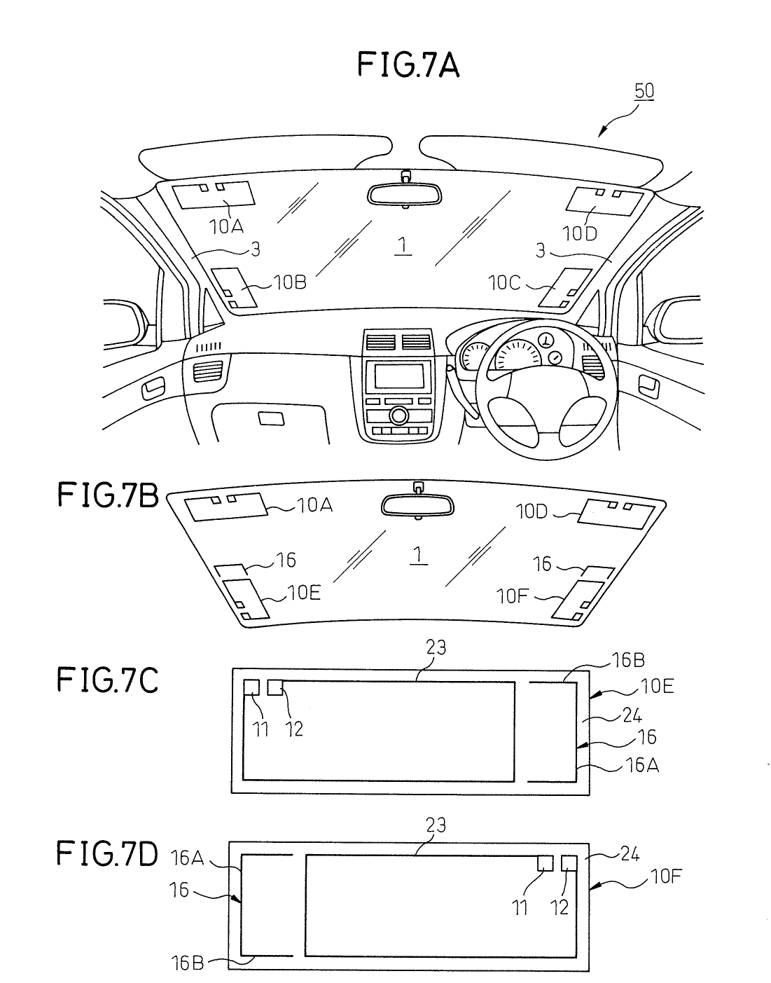

FIG. 7A is a view, seen from the vehicle interior, of the front windshield 1 of an automobile mounted with a vehicle antenna system 50 of a second embodiment of the present invention and the surroundings of the same. The antenna system 50 of this embodiment also receives radio waves emitted from the DTV and is comprised of four film antennas 10A, 10B, 10C, and 10D. The four film antennas 10A, 10B, 10C, and 10D are respectively connected to feed circuits comprised of connectors 20 and coaxial cables 22, however, depiction of the connectors 20 and coaxial cables 22 is omitted in this embodiment. Further, the signals received by the film antenna 10A, 10B, 10C, and 10D are processed in the same way as the first embodiment, so the explanation is omitted here.

In the second embodiment, among the four film antennas 10A, 10B, 10C, and 10D, the film antennas 10A and 10D are arranged the same as in first embodiment. However, the film antennas 10B and 10C are not provided at the top part of the front windshield 1 of the automobile, but near the left and right A pillars 3 at the lower part of the front windshield 1. At this time, the film antenna 10B is mounted at the bottom left part of the front windshield 1 rotated 90 degrees to the left of the mounted state in the first embodiment, so that the longitudinal direction of the antenna element is along the A pillar 3. Similarly, at this time, the film antenna 10C is mounted at the bottom right part of the front windshield 1 rotated 90 degrees to the right of the mounted state in the first embodiment, so that the longitudinal direction of the antenna element is along the A pillar 3.

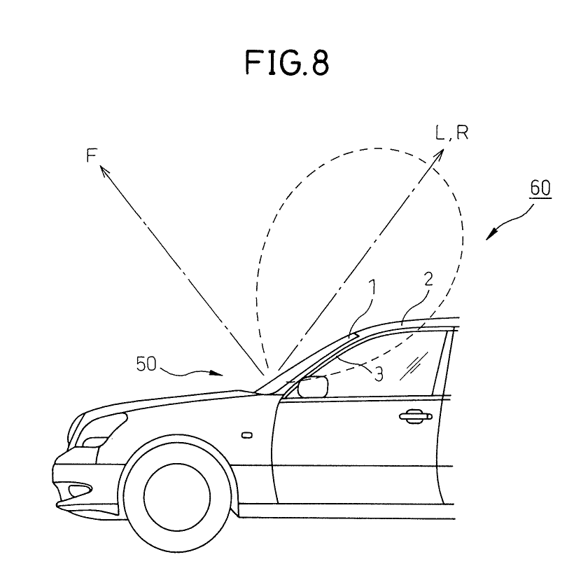

In the antenna system 50 of the second embodiment, compared with the directivity of the film antennas 10C and 10B explained with reference to FIGS. 6A and 6C, the directivity of the antenna system 50 in the vertical direction when the automobile 60 is seen from the side is closer to vertical as shown in FIG. 8. As a result, the radio waves of the DTV broadcast from the rear of the automobile 60 become easier to receive and the reception performance of the antenna system 50 is improved. Note that, the directivity shown by the broken line shows the approximate direction of the directivity and is not an accurate depiction of the directivity.

FIG. 7B is a view of only the front windshield 1 of the automobile, seen from the vehicle interior, showing the structure of a modification of the vehicle antenna system 50 shown in FIG. 7A. In this embodiment, in place of the film antennas 10C and 10B explained in FIG. 7A, film antennas 10E and 1OF provided with parasitic elements 16 are used. The film antennas 10E and 1OF are provided with the structures as shown in FIGS. 7C and 7D. Parasitic elements 16 are positioned adjacently near the antenna conductors 23 on the sides away from the feed terminals 11 and 12 on the transparent film 24. A parasitic element 16 comprises a portion 16A parallel to the shorter side (lateral side) of the antenna conductor 23 and a portion 16B which is an extension of the longer side (longitudinal side). The addition of a parasitic element 16 makes directivity more acute and improves antenna sensitivity.

Therefore, when the film antennas 10A, 10D, 10E, and 1OF are arranged on the front windshield 1 of the automobile 60 as shown in FIGS. 7A and 7B, the directivity of the antenna system 50 is as shown in FIG. 10B when the automobile 60 is seen from above, and the range over which DTV broadcasts can be received expands out to the rear of the vehicle with respect to the forward direction F of the vehicle as shown by the broken line. As a result, the vehicle is able to receive well radio waves of DTV broadcasts from the rear of the vehicle, and the reception performance of the antenna system 50 is improved. Note that, the directivity shown by the broken line in FIG. 10B does not show the actual directivity and only expresses an image of the effect of the present invention.

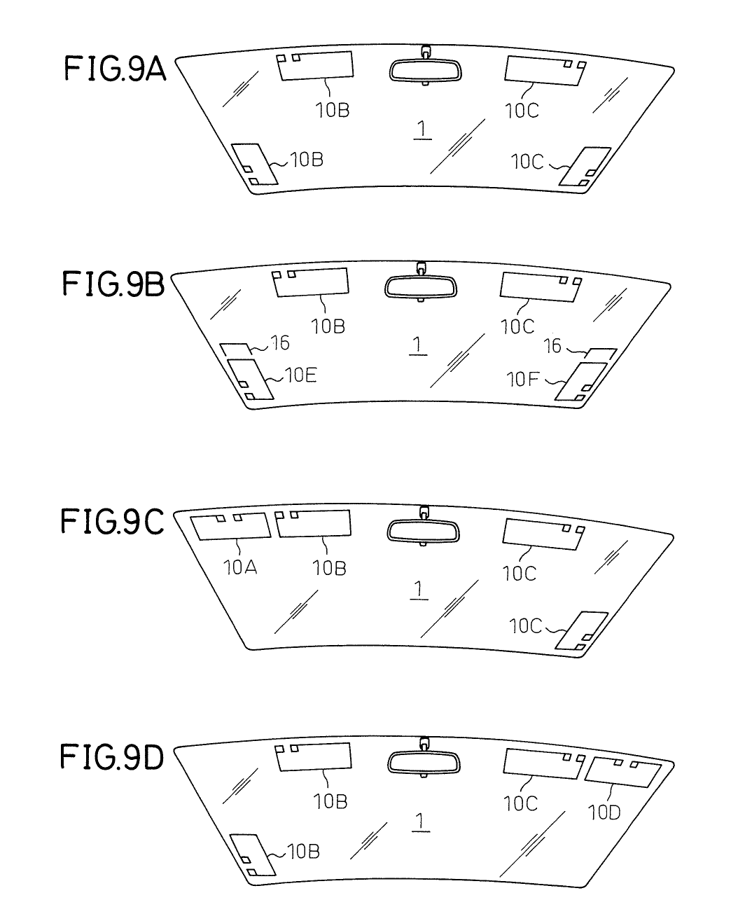

FIG. 9A is a view of only the front windshield 1 of the automobile, seen from the vehicle interior, when mounted with the vehicle antenna system 50 of the third embodiment of the present invention. The antenna system 50 of this embodiment is also for receiving DTV broadcasts. In the third embodiment, the antenna system 50 comprises two film antennas 10B and two film antennas 10C. Depiction of the connector 20 and coaxial cable 22 is omitted in this embodiment as well. Further, the signals received by the film antennas 10B and 10C are processed the same as in the first embodiment, so explanations are omitted here as well.

In the third embodiment, the film antennas 10B and 10C set at the top part of the front windshield 1 of the automobile are arranged the same as in the first embodiment. Further, the film antennas 10B and 10C set near the left and right A pillars 3 at the bottom part of the front windshield 1 of the automobile are arranged the same as in the second embodiment. Therefore, in the antenna system 50 of the third embodiment, the directivity of the antenna system 50 when the automobile 60 is seen from above is as shown in FIG. 10C. Note that, the directivity shown by the broken line in FIG. 10C does not show the actual directivity and only expresses an image of the effect of the present invention.

FIG. 9B is a view of only the front windshield 1 of the automobile, seen from the vehicle interior, showing the structure of a modification of the vehicle antenna system 50 of the third embodiment shown in FIG. 9A. What makes the modification different from the third embodiment is that instead of using film antennas 10B and 10C near the left and right A pillars 3 at the bottom part of the front windshield 1, film antennas 10E and 1OF having parasitic elements 16 are used. The parasitic elements 16 of the film antennas 10E and 10F, as already explained in FIG. 7C and 7D, are positioned adjacently near the antenna conductors 23. A parasitic element 16 comprises a portion 16A parallel to the shorter side of the antenna conductor 23 and a portion 16B extending to the longer side. The addition of a parasitic element 16 makes directivity more acute and improves antenna sensitivity.

FIG. 9C is a view of only the front windshield 1 of the automobile, as seen from the vehicle interior, when mounted with the vehicle antenna system 50 of the fourth embodiment of the present invention. In the fourth embodiment, when seen from inside the vehicle, the film antennas 10A and 10B at the left half are arranged the same as in the first embodiment, and the two film antennas 10C at the right half are arranged the same as in the third embodiment. Therefore, in the antenna system 50 of the fourth embodiment, the directivity of the antenna system 50 when the automobile 60 is seen from above is as shown in FIG. 10D. Note that, the directivity shown by the broken line in FIG. 10D does not show the actual directivity and only expresses an image of the effect of the present invention.

FIG. 9D is a view of only the front windshield 1 of the automobile, as seen from the vehicle interior, when mounted with the vehicle antenna system 50 of the fifth embodiment of the present invention. In the fifth embodiment, when seen from inside the vehicle, the film antennas 10C and 10D at the right half are arranged the same as in the first embodiment, and the two film antennas 10B at the left half are arranged the same as in the third embodiment. Therefore, in the antenna system 50 of the fifth embodiment, the directivity of the antenna system 50 when the automobile 60 is seen from above is as shown in FIG. 10E. Note that, the directivity shown by the broken line in FIG. 10E does not show the actual directivity and only expresses an image of the effect of the present invention.

1. A vehicle antenna system mounted on a fixed window set on a vehicle which is provided with
at least one loop antenna with directivity in a direction parallel to a vehicular length direction and
at least one loop antenna with directivity in a direction away from the direction parallel to the vehicle length direction, characterized in that
the loop antenna with directivity in a direction parallel to the vehicle length direction has two feed terminals symmetrically positioned with respect to a center line which bisects the loop antenna left and right and
the loop antenna with directivity in a direction away from the direction parallel to the vehicle length direction has two feed terminals positioned offset to either side of a center line which bisects the loop antenna left and right.

2. A vehicle antenna system mounted on a fixed window set on a vehicle, provided with
a loop antenna having two feed terminals which are symmetrically positioned with respect to a center line which bisects the loop antenna left and right,
a loop antenna having two feed terminals which are positioned offset to the right side of a center line which bisects the loop antenna left and right, and
a loop antenna having two feed terminals which are positioned offset to the left side of a center line which bisects the loop antenna left and right.

3. A vehicle antenna system as set forth in claim 1, wherein
the loop antenna with directivity in a direction parallel to the vehicular length direction comprises, viewed from a vehicle interior, a first loop antenna set at a top left of the window and a second loop antenna set at a top right of the window, and
the loop antenna with directivity in a direction away from the direction parallel to the vehicle length direction comprises, viewed from a vehicle interior, a third loop antenna set adjacent to the right side of the first loop antenna and a fourth loop antenna set adjacent to the left side of the second loop antenna.

4. A vehicle antenna system as set forth in claim 3, wherein the direction of offset for the two feed terminals provided by the third loop antenna is different than for that of the two feed terminals provided by the fourth loop antenna.

5. A vehicle antenna system as set forth in claim 4, wherein each of the third and fourth loop antennas is provided with
a conductor positioned parallel to an antenna element in a direction along the upper edge of the window and
a conductor positioned parallel to an antenna element in a direction perpendicular to the direction along the upper edge of the window.

6. A vehicle antenna system as set forth in claim 1, wherein
the loop antenna with directivity in a direction parallel to the vehicular length direction comprises, viewed from a vehicle interior, a first loop antenna set at the top left of the window and a second loop antenna set at the top right of the window,
the loop antenna with directivity in a direction away from the direction parallel to the vehicle length direction comprises, viewed from a vehicle interior, a third loop antenna set at the bottom left of the window and a fourth loop antenna set at the bottom right of the window, and
the direction of offset for the two feed terminals provided by the third loop antenna is different than for that of the two feed terminals provided by the fourth loop antenna.

7. A vehicle antenna system as set forth in claim 6, wherein
a line conductor that is not connected to an antenna element of the third loop antenna is adjacently positioned outside an antenna element on the side away from the feed terminals of the third loop antenna, and
a line conductor that is not connected to the antenna element of the fourth loop antenna is adjacently positioned outside an antenna element on the side away from the feed terminals of the fourth loop antenna.

8. A vehicle antenna system as set forth in claim 7, wherein
the line conductor comprises a conductor parallel to the antenna element of the third loop antenna and a conductor connected to both ends of the parallel conductor, and
the line conductor further comprises a conductor parallel to the antenna element of the fourth loop antenna and a conductor connected to both ends of the parallel conductor.

9. A vehicle antenna system as set forth in claim 1, wherein
the loop antenna with directivity in a direction parallel to the vehicular length direction comprises, viewed from a vehicle interior, a first loop antenna set at the bottom left of the window and a second loop antenna set at the bottom right of the window,
the loop antenna with directivity in a direction away from the direction parallel to the vehicle length direction comprises, viewed from a vehicle interior, a third loop antenna set at the top left of the window and a fourth loop antenna set at the top right of the window, and
the direction of offset for the two feed terminals provided by the third loop antenna is different than for that of the two feed terminals provided by the fourth loop antenna.

10. A vehicle antenna system as set forth in claim 9, wherein
a line conductor that is not connected to an antenna element of the first loop antenna is adjacently positioned outside an antenna element on the side away from the feed terminals of the first loop antenna, and
a line conductor that is not connected to the antenna element of the second loop antenna is adjacently positioned outside an antenna element on the side away from the feed terminals of the second loop antenna.

11. A vehicle antenna system as set forth in claim 10, wherein
the line conductor comprises a conductor parallel to the antenna element of the first loop antenna and a conductor connected to both ends of the parallel conductor, and
the line conductor further comprises a conductor parallel to the antenna element of the second loop antenna and a conductor connected to both ends of the parallel conductor.

12. A vehicle antenna system as set forth in claim 1, wherein
the loop antenna with directivity in a direction parallel to the vehicular length direction comprises, viewed from a vehicle interior, a first loop antenna set on either the top left or top right of the window,
the loop antenna with directivity in a direction away from the direction parallel to the vehicle length direction comprises, viewed from a vehicle interior, a second loop antenna and third loop antenna set in a direction along the upper edge of the window and a fourth loop antenna set on either the bottom left or bottom right of the window, and
the direction of offset for the two feed terminals provided by the second loop antenna is different than for that of the two feed terminals provided by the third loop antenna.

13. A vehicle antenna system as set forth in claim 12, wherein the two feed terminals of the fourth loop antenna are set offset to the body side of the vehicle with respect to the center line bisecting the fourth loop antenna left and right.

14. A vehicle antenna system as set forth in claim 13, wherein a line conductor that is not connected to an antenna element of the fourth loop antenna is adjacently positioned outside an antenna element on the side away from the feed terminals of the fourth loop antenna.

15. A vehicle antenna system as set forth in claim 14, wherein the line conductor comprises a conductor parallel to the antenna element of the fourth loop antenna and a conductor connected to both ends of the parallel conductor.
